(19) United States
(12) Patent Application Publication
(10) Pub. No.: US 2006/0075333 A1
(43) Pub. Date: Apr. 6, 2006

(54) Display device

(75) Inventor: Satoshi Nishiya, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/207,714

(22) Filed: Aug. 22, 2005

(30) Foreign Application Priority Data
Oct. 6, 2004 (JP) 2004-293385
Dec. 22, 2004 (JP) 2004-371046

(51) Int. Cl. G06F 17/00

(52) U.S. Cl. 715/523

(57) ABSTRACT

The present invention relates to a display device for data editing data for display acquired from outside and sending the edited data via a Web control to the Web browser for display thereon. In the present invention, a common data interface means unaffected by the type of Web control is introduced for editing data for display, thereby achieving a display device capable of property setting and data retention regardless of the data buffer name of a Web control.

### BACKGROUND OF THE INVENTION

1. Field of the Invention

The present invention relates to a display device provided with a means for screen application for acquiring and editing data for display, in response to a display request from the Web browser, and for returning an image for display thereto via a Web control.

2. Description of the Prior Art

The prior art for a data display device using a Web browser as a display mean is described in the following patent literature:

(Patent Document 1)

Gazette for Japanese Laid-open Patent Application No. 2002-41296

The diffusion of PCs and the Internet has lead to the widespread employment of display devices in whose Web servers a screen application using a Web browser as a display means is constructed. Screen applications are however poor in representation capability. Common components for supplementing this drawback are therefore essential for constructing a screen application. Such components are called Web controls.

Particular types of Web controls, such as data grids, tree views, tab sheets, and graphs, enable data display and operation in an easily understandable manner. Such types of Web controls are thus provided in screen applications as common components for general purposes.

A screen application forwards an image for display to the Web browser via a Web control. Prior to that, the screen application requires processing for each Web control by a data interface for editing and retaining the data for display acquired from the database.

FIG. 1 is a block diagram of an example configuration of a conventional display device. Block 1 is a Web server with means for screen application 10. Block 2 is a screen of a client PC with Web browser 20. Block 3 is a database server for updating and storing data for display via Web controls.

Web control A 11 in means for screen application 10 forwards an image for display (e.g., a graph) to Web browser 20, in response to a display request (Q) therefrom, to display a screen from Web control A 21.

Web control B 12 likewise forwards an image for display (e.g. grid) to display a screen from Web control B 22 on the Web browser. Web control C 13 similarly forwards an image for display (e.g. a tree) to display a screen from Web control C 23 on the Web browser.

Data input processing means A 14 in means for screen application 10 acquires data for display A from database 31, in response to a data transfer request (R) made to database server 3, and forwards the same to data edit processing means A 17.

Data input processing means B 15 likewise acquires data for display B from database 32 and forwards the same to data edit processing means B 18. Data input processing means C 16 similarly acquires data for display C from database 33 and forwards the same to data edit processing means C 19.

Data edit processing means 17, 18, or 19 edits data for display forwarded from data input processing means 14, 15, or 16 according to the data interface structure of Web control 11, 12, or 13 and retains the data for display in an appropriate Web control.

Upon completion of the aforementioned processes, a Web control of means for screen application 10 returns an image for display to Web browser 20, and a requested Web control screen is displayed thereon.

The underlying concept of conventional display devices is that Web controls are functions independent from and unrelated to each other. No common data interface is provided for Web controls of conventional display devices. Data must therefore be edited for each Web control to create a screen thereof.

In the configuration of conventional display devices, the creation of a Web control screen is inefficient due to the following problems:

(1) Complicated Data interface

Data display via a Web control is achieved by retaining data in the data buffer of the Web control. A data interface of a Web control is complicated because of having to perform various forms of representation.

When using a Web control, the name of the data buffer must be informed for retaining data in the buffer. As the number of Web controls increases, that of data buffers increases accordingly. The task of informing each buffer name accordingly becomes complicated.

(2) Complicated Property Settings

Property settings must be performed individually for Web controls, even when certain properties (e.g., font and font size) are uniformly set for the whole display system or one screen from a Web control. As the number of Web controls increases, the complexity of the accompanying property setting tasks increases accordingly.

(3) Data Input Processing Requiring Programming Descriptions

For data input processing, programming descriptions are needed to create a source program by specifying a data input destination and calling a data input method. This is an obstacle to the Web screen creation efficiency of users who are not skilled in programming.

### SUMMARY OF THE INVENTION

The present invention aims at achieving a display device where data retention can be performed for Web controls regardless of the data buffer names thereof and common property setting is possible.

The present invention further aims at achieving a display device which does not require programming descriptions for its data input.

### BRIEF DESCRIPTION OF THE DRAWINGS

FIG. 1 is a functional block diagram of an example configuration of a conventional display device.

FIG. 2 is a functional block diagram of an example embodiment of a display device employing the present invention.

FIG. 3 is a functional block diagram of a concrete configuration of a data interface means.

FIG. 4 is a flowchart of a signal processing procedure of a data interface means.

FIG. 5 is a list of XML descriptions for data for display.

FIG. 6 is an example grid display screen.

FIG. 7 is an example graph display screen.

FIG. 8 is a functional block diagram of a screen application focused on a configuration of a data input processing means.

FIG. 9 is a flowchart of a signal processing procedure from an input data definition means to a data interface means.

FIG. 10 is a transitional diagram of data processing contents corresponding to the flowchart in FIG. 9.

FIG. 11 is an image diagram of a Web screen program development environment using software components.

### DESCRIPTION OF THE PREFERRED EMBODIMENTS

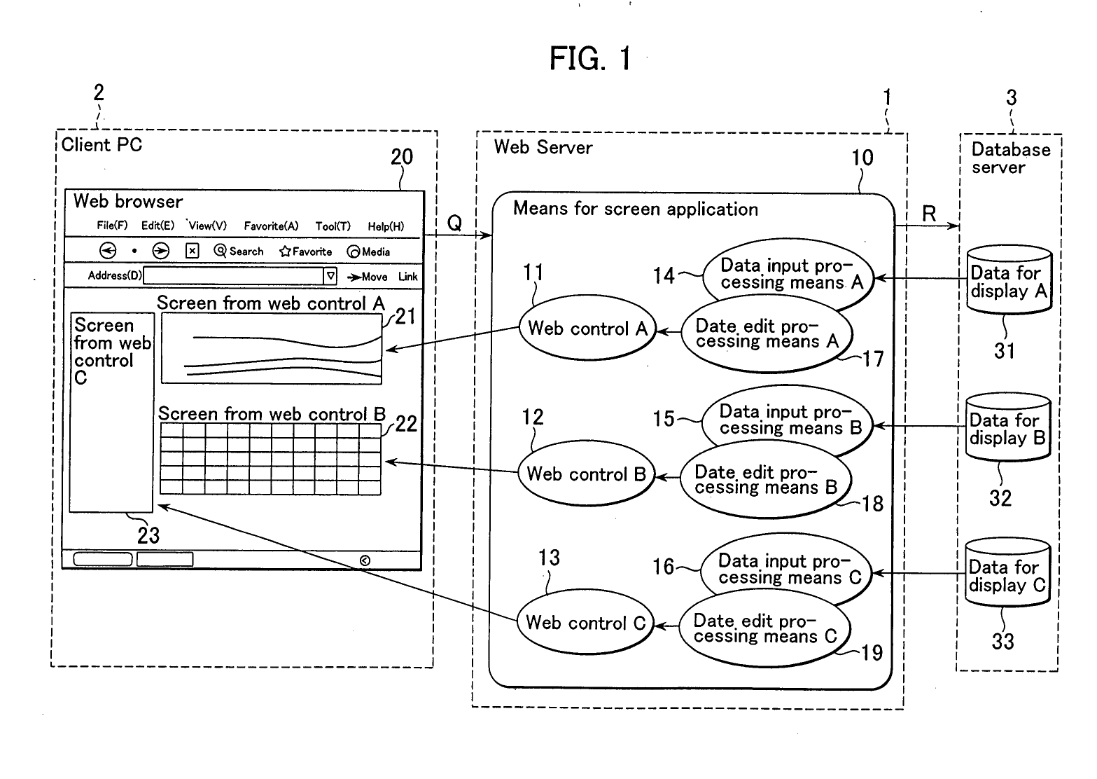

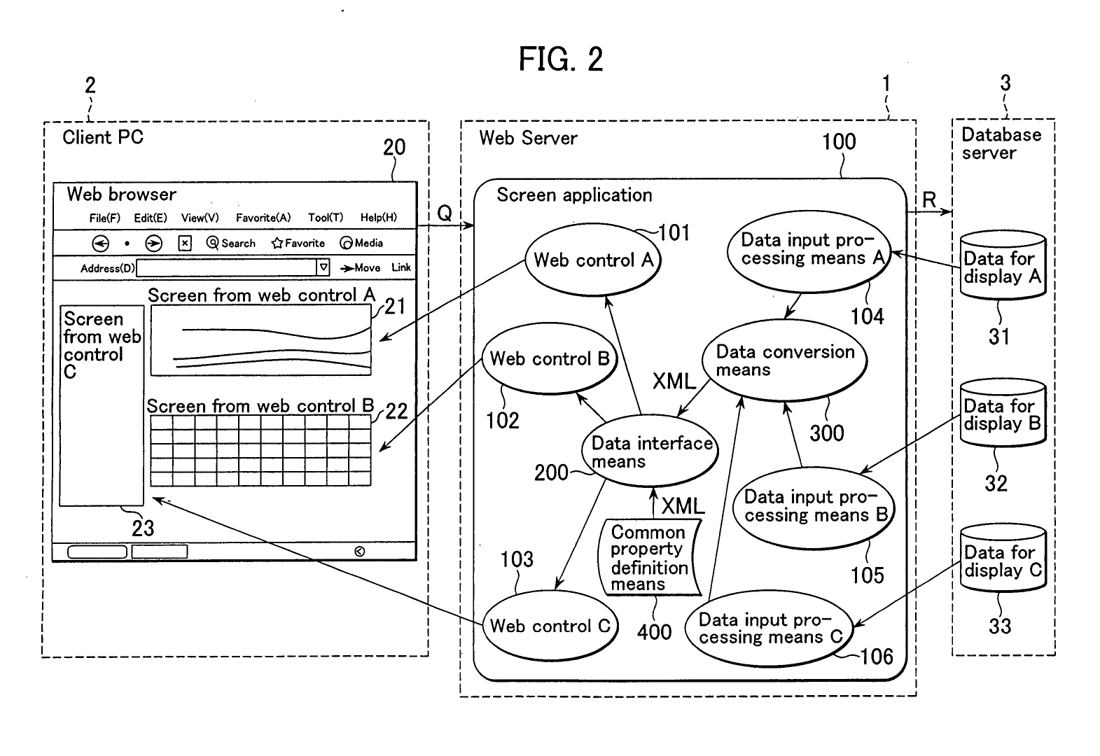

The present invention is described in detail below using the accompanying drawings. FIG. 2 is a functional block diagram of an example embodiment of a display device employing the present invention. The items that have already appeared in FIG. 1 are denoted by the same notations, so explanation is omitted. This section discusses the characteristics of the present invention.

The structural characteristics of the present invention are as follows:

(1) A common data interface for retaining data and setting properties in a uniform manner is introduced for different types of Web controls.

(2) A common property definition means is introduced for common property setting for different types of Web controls.

(3) A data conversion means is introduced for converting data for display into data in a general-purpose data description language to be forwarded to the common data interface and then to a Web control.

(4) Data input processing obviating programming descriptions is provided through the unification of input data definitions.

In FIG. 2, means of screen application 100 employs the present invention. The functions of Web controls 101-103 and data input processing means 104-106 in FIG. 2 are the same as those of Web controls 11-13 and data input processing means 14-16 in FIG. 1, respectively, so explanation is omitted.

Components unique to the present invention are data interface means 200, data conversion means 300, and common property definition means 400. Data interface means 200 acquires data for display converted into a general-purpose description language and forwarded from data conversion means 300 and common property information forwarded from common property definition means 400. Data interface means 200 then performs editing for a data interface of each Web control, the retention of the data for display, and property setting.

The Extensible Markup Language (XML) is the most common general-purpose data description language adoptable in the present invention. Other data description formats, such as the Comma Separated Value (CSV) and the Tab Separated Value (TSV), can also be employed in the present invention. XML is however used here to explain an embodiment of the present invention.

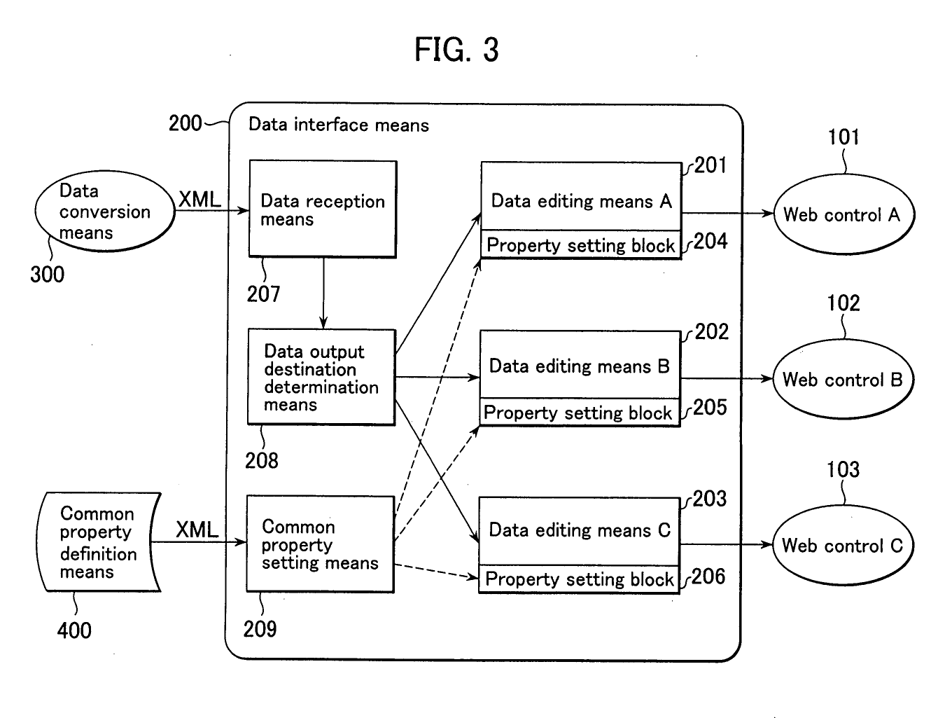

FIG. 3 is a functional block of a concrete configuration of data interface means 200. Data editing means A 201, B 202, and C 203 perform data editing for Web controls A 101, B 102, and C 103, respectively.

Property setting blocks 204, 205, and 206 perform property setting for data editing means A 201, B 202, and C 203, respectively.

Data reception means 207 acquires property definition information and data for display from data conversion means 300, that have been converted into XML for each Web control and forwards the acquired data to data output destination determination means 208.

Data output destination determination means 208 finds the ID of a Web control in the forwarded data for display and property information and acquires the type of the Web control from the ID. According to the information on the Web control type, data output destination determination means 208 forwards the data for display to data editing means 201, 202, or 203 and the property definition information to property setting block 204, 205, or 206.

Common property setting means 209 retains the property definition information in XML forwarded from common property definition means 400 and forwards common property definition information to property setting block 204, 205, or 206.

Property setting block 204, 205, or 206 performs individual settings for property setting information specific to a certain Web control forwarded from data conversion means 300 as well as for property setting information common to the Web controls forwarded from common property definition means 400. The individual property setting takes precedence over the common property setting.

Data editing means A 201, B 202, or C 203 retains XML-described data in a data interface of an appropriate Web control. If a program to perform the procedure of the initial process is created, the same program can be used for subsequent processes since the data format has been unified.

If a package comprising necessary editing means for Web controls, as demonstrated by data interface means 200, is made available, it can be used as a general-purpose software component, thereby significantly increasing the efficiency of Web screen design tasks.

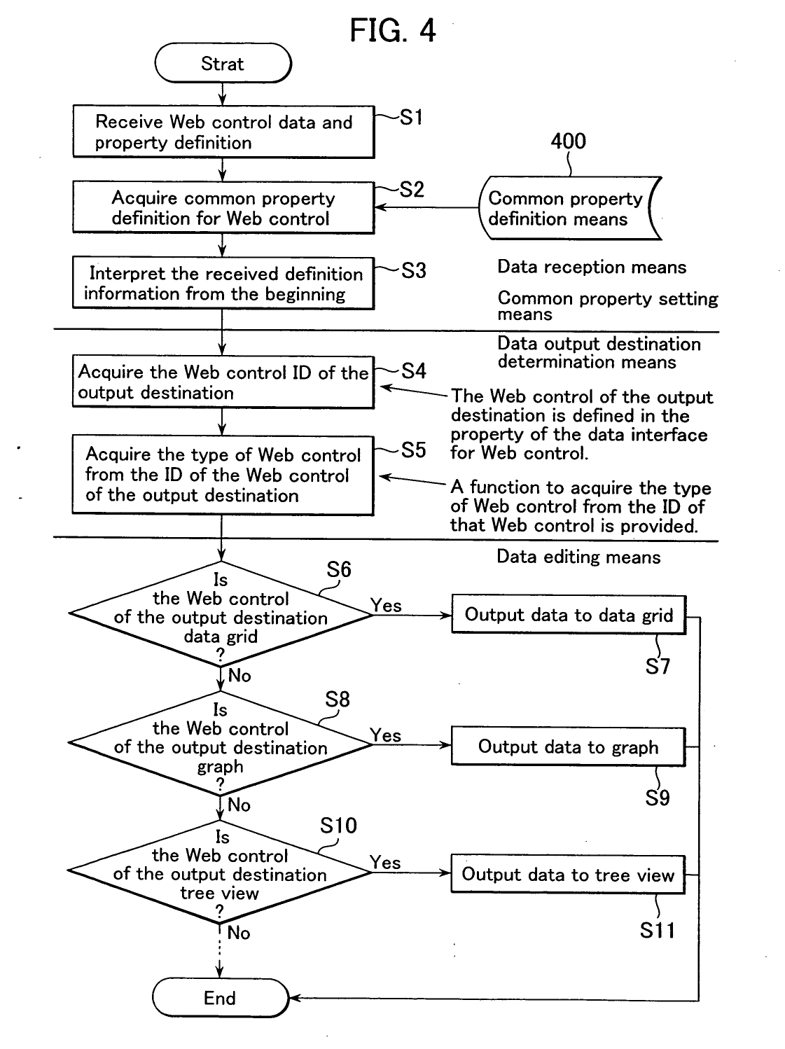

FIG. 4 is a flowchart of a signal processing procedure of data interface means 200. After the processing starts, Steps 1-3 are sequentially executed by data reception means 207 and common property setting means 209.

In Step 1, property definition information and data for display to be forwarded to a Web control are received from data conversion means 300. In Step 2, common property definition information for the Web controls is received from common property definition means 400. In Step 3, the definition information in XML is interpreted from the beginning thereof.

Steps 4 and 5 are processes executed by data output destination determination means 208. In Step 4, the ID of the Web control for which data are destined is acquired. Along with property information, this ID is described at the beginning of the XML-format information. In Step 5, a function available for identifying the type of the Web control from the acquired ID is used.

Steps 6-11 are processes executed by data editing means 201, 202, and 203, one of which is selected according to the decision by data output destination determination means 208. If the output destination is determined to be data grid in Step 6, data are output to the data editing means of the Web control for data grid in Step 7.

If the output destination is determined in Step 8 to be a graph, data are output to the data editing means of the Web control for a graph in Step 9. In Step 10 if the output destination is determined to be a tree view, data are output to the data editing means of the Web control for a tree view in Step 11. The signal processing procedure is completed as data editing is completed for all types of Web controls.

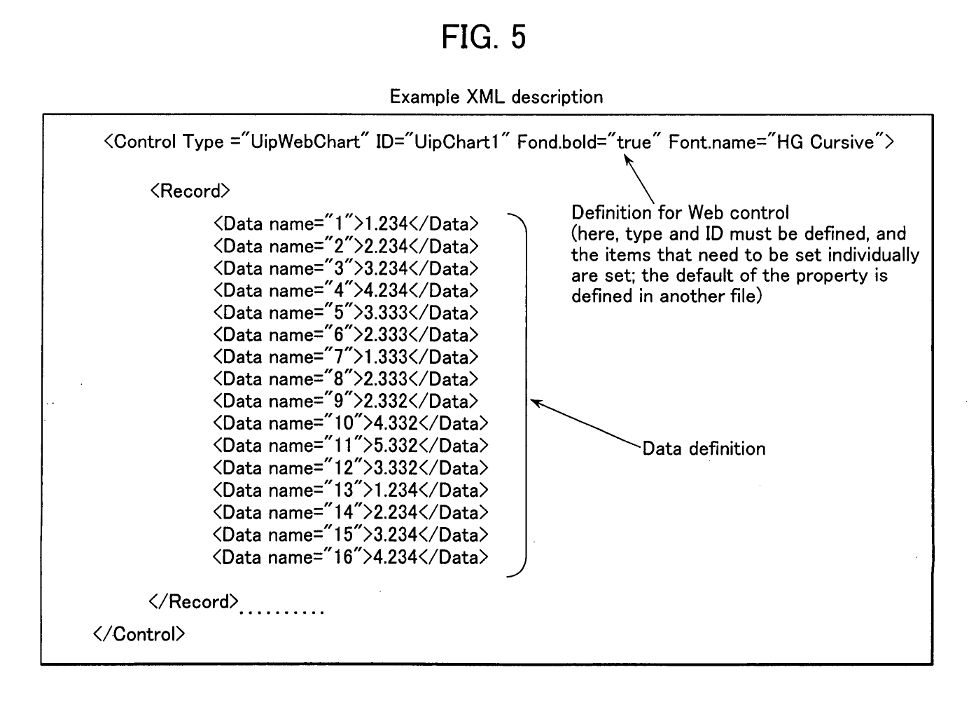

FIG. 5 is a list of XML descriptions for data for display. In the first line with tags, certain types of property definition information, such as TYPE, ID, and font, are described. In the following <Record> area, numerical information is described.

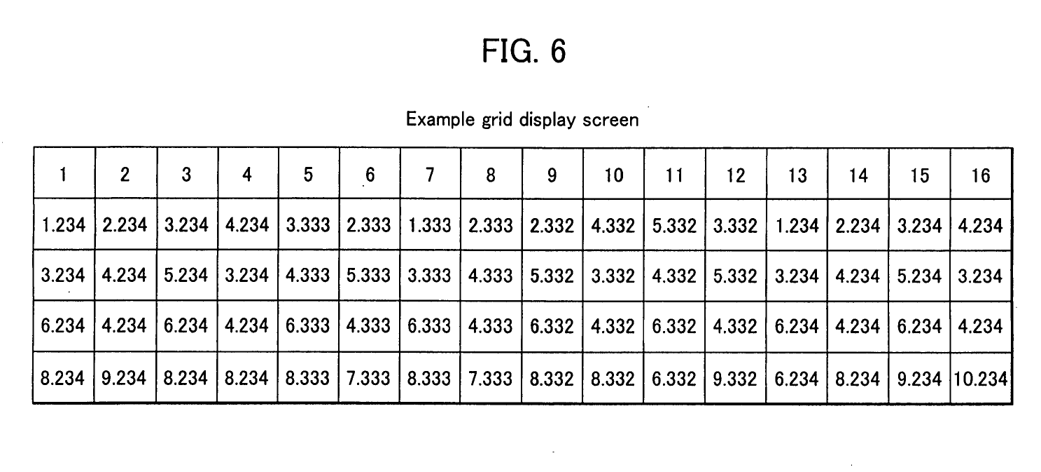

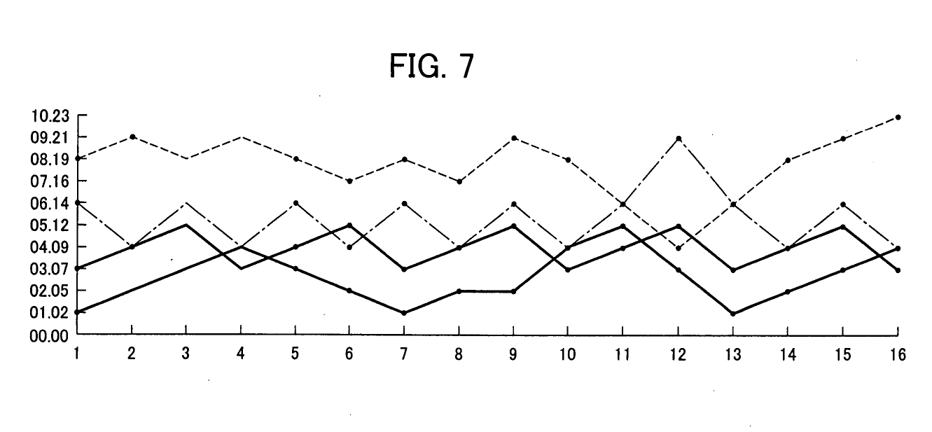

FIG. 6 is an example grid display screen produced from the numerical information in FIG. 5. FIG. 7 is an example graph display screen produced from the same numerical information. XML-described data for display contain definitions for the connection between the data for display and a Web control. To use the same data for different controls, only the TYPE and ID therein need to be corrected, and the rest of the data does not require editing.

When displaying a series of data on the browser screen in the forms of a graph (analog data) and a table (digital data), data descriptions are unified according to XML descriptions of the data for display. Screen application design tasks are streamlined accordingly, thereby offering significant advantages.

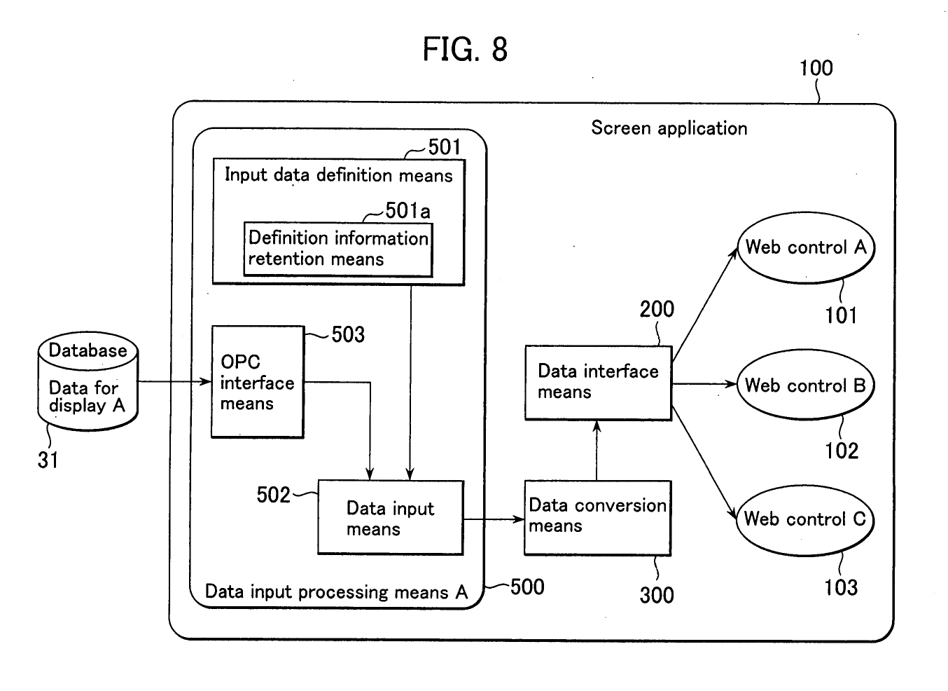

In FIG. 8-10, a data input processing environment without programming descriptions achieved through the unification of input data definitions is explained. FIG. 8 is a functional block diagram of screen application 100 focused on the configuration of a data input processing means.

In FIG. 8, data input processing means A 500 employs the present invention (104 in FIG. 2). Data for display A in Database 31 are input into data input processing means A 500, where a process to forward the input data to data conversion means 300 is executed. The same process is executed by data input processing means B and C.

Input data definition means 501 defines the format of data for display. Data input means 502 is used for the inputting of an input data definition created by input data definition means 501 and data for display from database 31 via OLE for Process Control (OPC) interface means 503.

Data input means 502 fetches an input data item name from a definition of input data as XML and forwards the input data item name and the data for display acquired via OPC interface means 503 to data conversion means 300.

Input data definition means 501 is comprised of definition information retention means 501a. When there is no definition of data as XML in the definition information, input data definition means 501 acquires input data defined in the property of the definition information and creates a definition of input data as XML. When there is a definition of data as XML in the definition information, input data definition means 501 acquires the definition as XML.

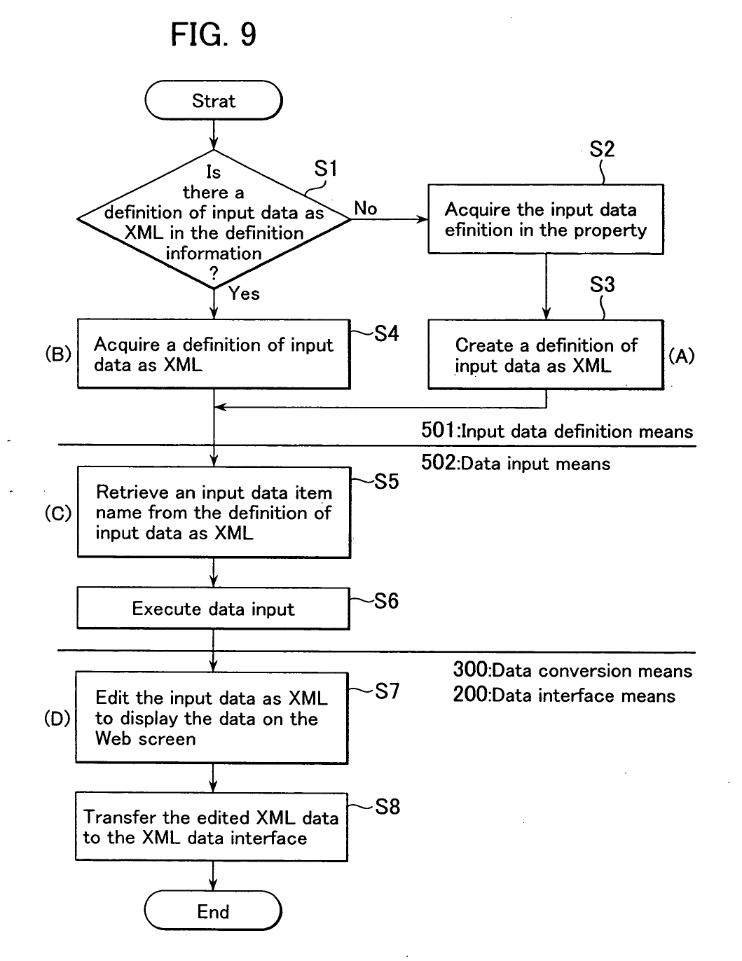

FIG. 9 is a flowchart of a signal processing procedure from input data definition means 501 to data interface means 200. Input data definition means 501 executes the processes in Steps 1-4.

In Step 1, whether a definition of input data as XML exists or not in the definition information is checked. If the definition does not exist therein, the definition of input data in the property of the definition information is acquired in Step 2, and a definition of input data as XML is created in Step 3. The processes in Steps 2 and 3 are denoted as (A).

When a definition of input data as XML is found in the definition information by the checking process in Step 1, the definition as XML is acquired in Step 4, whose process is denoted as (B).

The processes in Steps 5 and 6 are executed by data input means 502. An input data item name is fetched from the definition of input data as XML in Step 5, and data for display are acquired via OPC interface means 503 in Step 6. The process in Step 5 is denoted as (C).

Steps 7 and 8 are processes executed by data conversion means 300 and data interface means 200, respectively. In Step 7, input data are edited as XML data to be displayed on the Web screen. In Step 8, the edited XML data are forwarded to data interface means 200. The process in Step 7 is denoted as (D).

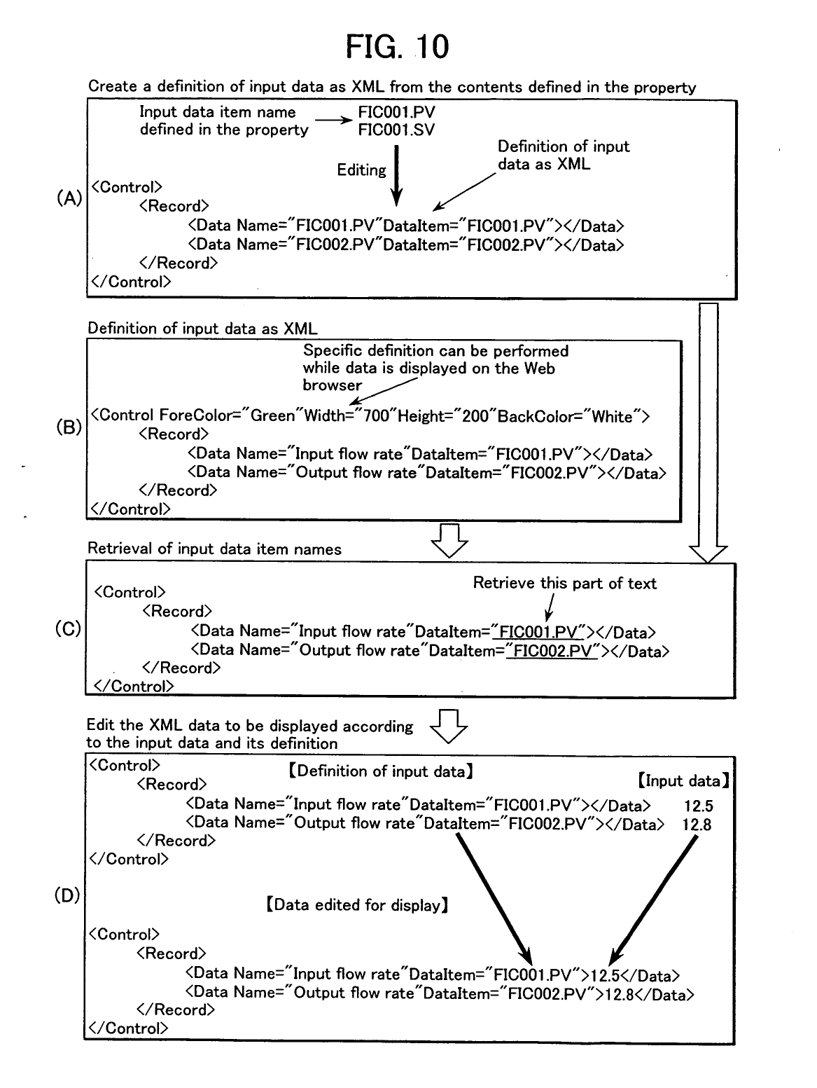

FIG. 10 is a transitional diagram of data processing contents corresponding to the flowchart in FIG. 9. A sequence of Blocks (A), (B), (C), and (D) in FIG. 10 correspond to the processes denoted by (A), (B), (C), and (D) in the flowchart of FIG. 9.

In (A), a definition of input data as XML does not exist in the definition information. The data item name defined in the property is acquired and edited to create a definition of input data as XML. In (B), a definition of input data as XML exists in the definition information, so the definition of input data as XML is acquired therefrom. In this case, specific definition can be performed while the data are displayed on the Web browser.

In (C), an input data item name is fetched from the definition of input data as XML. In (D), the data for display are edited as XML data based on input data (numerical) acquired via OPC interface means 503 and the input data definition.

Data interface means 200, data conversion means 300, and data input processing means 500 are developed as separate software components. In an environment where such components are implemented as executable programs, the differences in these components are of no concern for Web screen developers.

For Web screen application development, a software development tool is needed. A development tool with an image editor function for directly editing an image displayed on the screen is generally used.

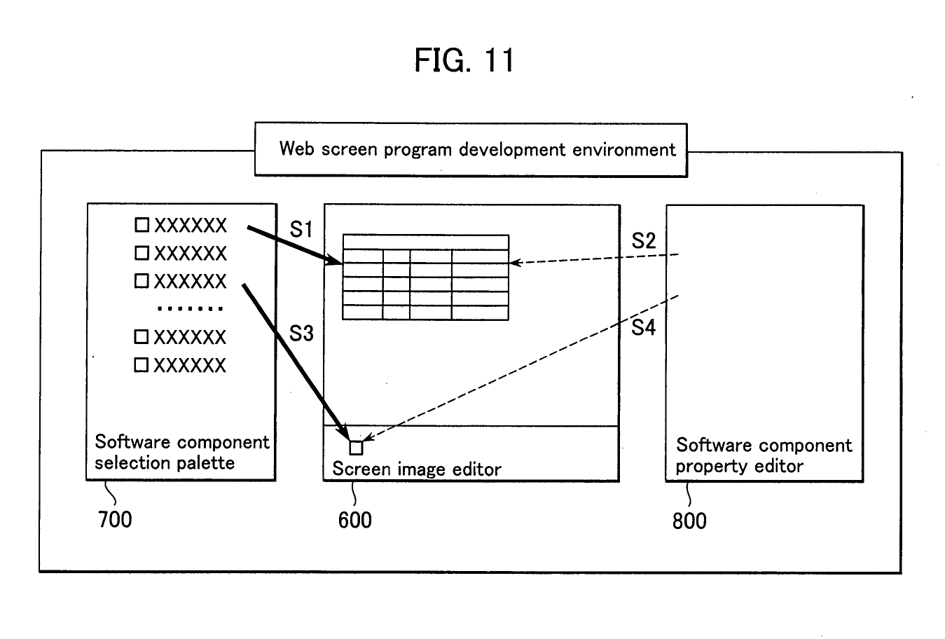

FIG. 11 is an image diagram of a Web screen program development environment using software components, comprised of screen image editor 600, software component selection palette 700, and software component property editor 800.

In Steps 1-4 below, a general procedure to develop a Web screen application using screen image editor 600 is explained:

(S1) Select a software component for display (e.g., grid) using software component selection palette 700 and place the selected software component on screen image editor 600.

(S2) Input and set values of properties (color, font name, and font size) of the placed software component using software component property editor 800.

(S3) Select “Implementation” (name of item displayed: OPC data object, etc.) using software component selection palette 700 and place the implemented item on screen image editor 600.

(S4) As in the case of Step 2, input and set values of properties of the implemented item also using software component property editor 800. The properties to be set are as follows:

(1) Definition of input data (XML file name or input data name)

(2) Name of software component for displaying input data (the item placed on screen image editor 600 in Step 1)

As noted above, work required for Web control screen development can be significantly reduced because the present invention offers the following advantage:

(1) Introduction of a common data interface means for all types of Web controls enables property setting and data retention in Web controls regardless of the buffer names thereof, thereby simplifying tasks for handling Web controls.

(2) Data retention and property setting can be performed in the same way for all types of Web controls, thereby obviating data editing for each Web control. For example, even when the same data are displayed on one screen from a Web control in a plurality of forms of representation, the data to be displayed can be set in a unified form.

(3) A property setting can be constructed for a plurality of Web controls by common property definition. Property setting for each control is unnecessary where the common property definition is effective. Individual property setting is assigned precedence over common property setting, thereby streamlining property setting tasks.

(4) Programming descriptions for data input processing, which entails the creation of a source program by specifying the input destination and calling the data input method, are unnecessary, thereby enhancing the efficiency of Web screen development by users who are not skilled in programming.

1. A display device for acquiring and editing data for display, in response to a display request from a Web browser, and returning an image for display to said Web browser via a Web control, comprising:
a data conversion means for converting said acquired data for display into data in a general-purpose data description language; and
a data interface means for acquiring said converted data for display and executing data editing for said Web control.

2. The display device in accordance with claim 1, wherein said data interface means is comprised of a data output destination determination means for acquiring a Web control ID from said converted data for display and acquiring, from said Web control ID, the type of a Web control whereto said data is to be output.

3. The display device in accordance with claim 1 or 2, wherein said data interface means is further comprised of a means for common property setting for acquiring common property information to be retained in said Web control.

4. The display device in accordance with claim 3, wherein said Web control is comprised of a property setting block for setting specific properties, whereto precedence is assigned over said common property setting.

5. The display device in accordance with claim 1 or 2, wherein said general-purpose data description language is XML.

6. The display device in accordance with claim 1 or 2, comprising:
an input data definition means for defining the format of said data for display; and
a data input means for inputting an input data definition created by said input data definition means and said data for display acquired via an OPC interface means.

7. The display device in accordance with claim 6, wherein said input data definition means, when no definition of data as XML exists in definition information, acquires input data defined in properties thereof and creates a definition of input data as XML, and, when there is a definition of data as XML, said input data definition means acquires input data in XML.

8. The display device in accordance with claim 7, wherein said data input means fetches an input data item name from a definition of input data as XML and forwards data for display acquired via said OPC interface means and said input data item name to said data conversion means.

9. The display device in accordance with claim 1 or 2, wherein said data input means, said data conversion means, and said data interface are developed as software components.
